(19) United States
(12) Patent Application Publication
(10) Pub. No.: US 2018/0146838 A1
(43) Pub. Date: May 31, 2018

(54) Lint Removal Device

(71) Applicant: RThriving Ventures LLC, West Hartford, CT (US)

(72) Inventor: Raphael J. Thomas, West Hartford, CT (US)

(21) Appl. No.: 15/821,423

(22) Filed: Nov. 22, 2017

Related U.S. Application Data
(60) Provisional application No. 62/426,488, filed on Nov. 26, 2016.

(51) Int. Cl. A47L 25/08; A47L 25/00; A46B 9/00; G09F 23/00

(52) U.S. Cl. CPC A47L 25/08; A47L 25/005; A46B 2200/3053; G09F 23/00; A46B 9/005

(57) ABSTRACT

Lint removal devices are disclosed. Lint removal devices include a base layer and a lint removal material layer that is connected to the base layer. Lint removal device base layers are particularly well suited for promotional images. Systems including lint removal devices also can include receiving sleeves configured to removably retain lint removal devices.

### CROSS-REFERENCE TO RELATED APPLICATIONS

The present application claims priority to U.S. Provisional Patent Application No. 62/426,488, filed on Nov. 26, 2016, the disclosure of which is hereby incorporated by reference in its entirety.

### FIELD OF THE DISCLOSURE

The present disclosure relates to arrangements, features, and methods for lint removal devices. The methods and devices find applications in various implementations, such as promotional materials.

### BACKGROUND

Various methods promote vendors through the use of cards or customization of standard devices. Brand presence is often achieved through a combination of advertising and frequency. A challenge faced by some businesses is increasing the number of impressions per advertisement through promotional products.

Typically, vendors provide business cards or promotional devices to customers as a form of advertising. Because business cards and promotional devices are typically circulated in large numbers, potential customers often will discard them or place them in a location and forget about them. Conventional promotional devices include pens, bottles, and bags.

### SUMMARY

Techniques and apparatus disclosed herein relate to lint removing devices particularly well suited to promotional applications. Lint removing devices disclosed and contemplated herein can include functional surfaces in addition to lint removing material.

In one aspect, a lint removal device includes a base layer and a lint removal material layer. The lint removal material layer is connected to the base layer and includes lint removing features. The lint removing features are arranged and configured to collect lint. The lint removal material layer is sized such that base layer edges are substantially flush with lint removal material layer edges.

In another aspect, a lint removal device system includes a lint removal device and a sleeve configured to receive the lint removal device. The lint removal device includes a base layer and a lint removal material layer, where the lint removal material layer is mounted on the base layer and includes lint removing features. The lint removing features are arranged and configured to collect lint. The lint removal material layer is sized such that base layer edges are substantially flush with lint removal material layer edges.

In another aspect, a lint removal device includes a base layer and a lint removal material layer. The base layer has a thickness no greater than 5 mm and includes promotional matter. The lint removal material layer is adhesively connected to the base layer and includes lint removing features arranged and configured to collect lint. The lint removal material layer is sized such that base layer edges are substantially flush with lint removal material layer edges.

The details of one or more embodiments are set forth in the accompanying drawings and the description below. It is to be understood that both the foregoing summary of the disclosure and the following detailed description are exemplary and intended to provide further explanation without limiting the scope of the disclosure.

### BRIEF DESCRIPTION OF THE DRAWINGS

The following figures, which form a part of this application, are illustrative of described technology and are not meant to limit the scope of the claims in any manner.

FIG. 1 is a schematic diagram of an example environment wherein a lint removal device is used.

FIG. 2 is a schematic side cross-sectional view of a lint removal device of the environment of FIG. 1.

FIG. 3 is a schematic side cross-sectional view of another embodiment of lint removal device of the environment of FIG. 1.

FIG. 4 is a schematic side cross-sectional view of another embodiment of lint removal device of the environment of FIG. 1.

FIG. 5 is a top, front right perspective view of lint removal device.

FIG. 6 is a front plan view of lint removal device.

FIG. 7 is a left side plan view of lint removal device.

FIG. 8 is a right side plan view of lint removal device.

FIG. 9 is a bottom plan view of lint removal device.

FIG. 10 is a top plan view of lint removal device.

FIG. 11 is a top, front left perspective view of sleeve.

FIG. 12 is a front plan view of sleeve.

FIG. 13 is a rear plan view of sleeve.

FIG. 14 is a left side plan view of sleeve.

FIG. 15 is a right side plan view of sleeve.

FIG. 16 is a top plan view of sleeve.

FIG. 17 is a bottom plan view of sleeve.

FIG. 18 is a top view of a pre-mated lint removal device and sleeve.

FIG. 19 shows the system of FIG. 18 in a partially-mated state.

FIG. 20 is a top view of a partially-mated lint removal device and another embodiment of a sleeve.

FIG. 21 shows the sleeve of FIG. 20.

FIG. 22 is a top, right front perspective view of another embodiment of a lint removal device.

FIG. 23 is an exploded view of another embodiment of a lint removal device.

FIG. 24 is a side plan view of the lint removal device of FIG. 23.

FIG. 25 illustrates another embodiment of a lint removal device system.

FIG. 26 is a perspective view of another embodiment of a lint removal device.

FIG. 27 illustrates another embodiment of a lint removal device.

### DETAILED DESCRIPTION

Various embodiments of the present invention will be described in detail with reference to the drawings, wherein like reference numerals represent like parts and assemblies throughout the several views. The features described herein are examples of implementations of certain broad, inventive aspects which underlie the disclosure.

Broadly, lint removal devices and systems described herein provide functional surfaces as well as surfaces configured for displaying promotional images. Generally, lint includes undesired particles on a particular surface, such as clothing or furniture. As used herein, “lint” includes small particles, such as dust and textile fibers, as well as hair, such as animal and human hair.

Lint removing functionality is provided by lint removing material, such as specialized lint removal fabric. In some particularly advantageous embodiments, promotional lint removing devices disclosed herein are designed to fit in a pocket and/or wallet, similar to a credit card. Additional functionality provided in various embodiments includes merchandising, value transfer, and authentication.

Grooming is a common consideration for those that come in frequent contact with hair shedding animals. One key to advertising is to have the ability to place a name or logo in front of a customer numerous times to increase consumer attention to source and identity, but most products lack functionality that benefits the consumer beyond vendor information to create reoccurring interactions. It is with respect to this general environment that the instant disclosure is directed.

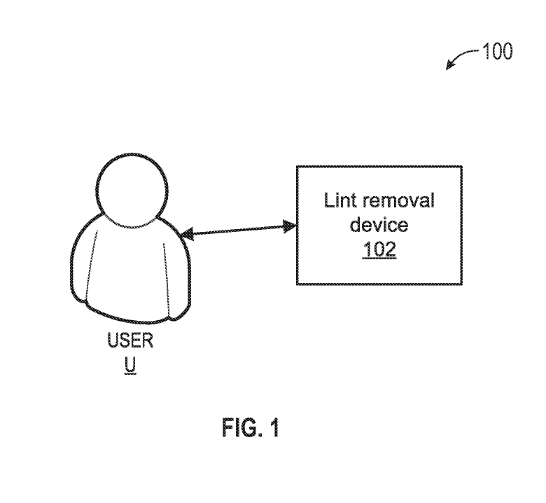

FIG. 1 illustrates an example environment 100 wherein a lint removal device is used. Environment 100 includes lint removal device 102 and user U. Generally, lint removal device 102 includes lint removing material arranged and configured to remove lint from the target surface. For example, user U may employ lint removal device 102 on various surfaces, such as a shirt, pants, couch and the like. That is, lint removal device 102 can be applied to surfaces on user U as well as other surfaces within user U's reach.

Broadly, lint removal device 102 provides lint removing functionality as well as one or more other functionalities. For instance, lint removal device 102 can include promotional material. Lint removal device 102 can also include various other functional and/or aesthetic surfaces, such as microfiber material.

Typically, lint removal device 102 is sized such that it can fit in pockets, such as pant pockets, shirt pockets, and the like. Usually, lint removal device 102 is slightly thicker than a typical credit card, such that it can be positioned within a wallet or other container without occupying significant amounts of space.

User U receives lint removal device 102 from a third party, such as a vendor. Because of various functionalities provided by lint removal device 102, user U is incentivized to retain lint removal device 102, for example, to use lint removal device 102 for grooming and/or cleaning. This result can be mutually beneficial for both user U and the third party. For instance, user U received a product that solves an everyday need and the third party achieves increased customer impressions through the use of lint removal device 102.

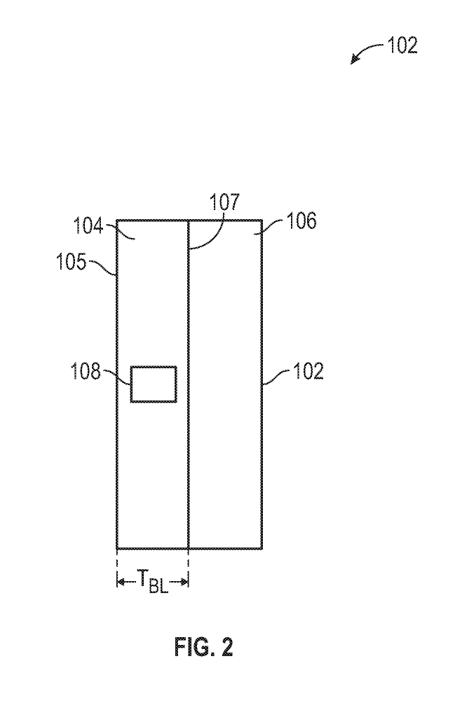

FIG. 2 is a schematic cross-sectional view of example lint removal device 102. The example embodiment of lint removal device 102 shown in FIG. 2 includes two layers: base layer 104 and lint removal material layer 106. Optionally, lint removal device 102 can include base layer additive 108.

Base layer 104 provides a substrate to which lint removal material layer 106 is adhesively connected. In some instances, lint removal material layer 106 is connected to base layer 104 through some other layer. Typically, base layer 104 is a firm, but flexible, material having a thickness greater than a pre-determined amount. For example, base layer 104 has a thickness T_{BL} of no less than 0.75 millimeters (mm). In some embodiments, base layer 104 has a thickness T_{BL} of 0.76 mm.

Lint removal device 102 usually has a thickness T_{BL} no greater than 5 mm. Typically, when lint removal device 102 is configured to fit in a pocket or wallet, base layer 104 has a thickness T_{BL} between 0.75 mm and 1.25 mm, inclusive. In these embodiments, lint removal device 102 typically has width and length dimensions about those of a standard credit card: a width of about 3 to 4 inches and a length of about 2 to 2.5 inches. Alternative width and length dimensions are possible, such as 3.5 in×2.5 in; 3.5 in×2.25 in; 85.60 mm×53.98 mm; and 3.5 in×2 in. In other embodiments, lint removal device 102 has a width and/or length greater than 3 inches, such as 4 inches, 5 inches, or 6 inches.

Base layer 104 includes opposite surfaces 105 and 107. Surface 107 is in contact with lint removal material layer 106. In most implementations, an adhesive is applied between surface 107 and lint removal material layer 106, thereby adhesively connecting lint removal material layer 106 to base layer 104. Alternatively, or in combination, lint removal material layer 106 is connectably woven with base layer 104 with thread.

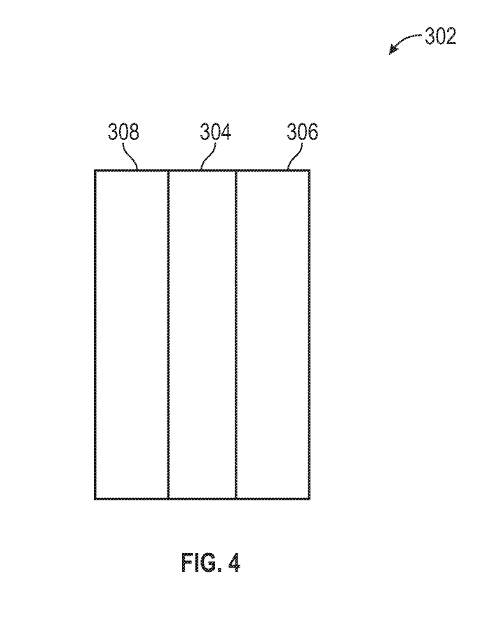

Surface 105 provides a medium for promotional print, instructions or additional layers to be adhered or secured thereto. Promotional content can include identity, logo, address, phone number, name, email, slogan, deal, and scanable codes such as bar codes and QR codes. Embodiments including other layers connected to surface 105 are described in more detail below, with particular reference to FIG. 4.

Base layer 104, as mentioned above, is a firm but flexible material having thickness T_{BL}. Typically, base layer 104 is substantially planar and has little or no curvature, which can be evident when viewed from the front or side. In some instances, because of design or manufacturing techniques, base layer 104 is planer but has some curvature, which can be evident when viewed from the front or side.

Depending upon the implementation, thickness T_{BL} may vary. Base layer 104 can be a composite material. Base layer 104 can be one or more layers of the same material, such as when base layer 104 is produced using successive deposition techniques like 3D printing. Base layer 104 can also be one or more layers of different material, such as a plastic layer and a cardboard layer. In some embodiments, base layer 104 and lint removal material layer 106 are not separate layers, such as when lint removal device 102 is manufactured using 3D printing or injection molding.

Base layer 104 optionally can include base layer additive 108. Base layer additive 108 can be one or more additives having functionality. For example, base layer additive 108 may be a magnetic component. In some instances the magnetic component can be a rare earth magnet. The magnet component can be positioned entirely within base layer 104. Alternatively, the magnetic component can extend between surfaces 105 and 107. Other configurations of magnetic component relative to base layer 104 are contemplated. Another example base layer additive 108 is antimicrobial material. Example antimicrobial material includes zeolites.

Depending on the implementation, base layer 104 can be one or many types of supportive structures. In some instances, base layer 104 is a thermoplastic. An example thermoplastic is an acrylonitrile-butadiene-styrene (ABS) resin (CAS No. 9003-56-9) based product. Base layer 104 can one or more other materials, or mixtures of materials. Examples include a polyvinyl chloride (PVC) based material, a polypropylene based material, and/or a silicon based material. As another example, base layer 104 is a cardboard material.

In some implementations, base layer 104 is a structure other than a card-sized surface. For example, base layer 104 can be a personal care product. An example personal care product is a makeup kit or compact case. As another example alternative of base layer 104 is a mobile device case. Yet another example of base layer 104 is a hotel key material.

Lint removal material layer 106 is a layer specifically designed to remove lint from surfaces. Lint removal material layer 106 may be applied multiple times to various surfaces, such as cloth material, to remove lint when a brushing motion is applied. Lint removal material layer 106 includes lint removing features. Example lint removing features include bristles or protrusions arranged to collect lint, typically in a uniform pattern. Lint removing features can be erect or angled. The quantity and orientation of lint-removing features of lint removal material layer 106 shown in the Figures are for illustrative purposes only.

In some instances, lint removal material layer 106 is made of lint removal fabric. Lint removal fabric typically includes polyester and/or nylon material arranged as sloped bristles to capture lint, dust, and other particles. In some instances, lint removal material layer 106 can be made of a rubber-based material and including a plurality of lint-removing features, such as bristles or knobs. In some instances, lint removal material layer 106 is capable of electrostatic induction to aid or improve lint removing capability.

Depending on the implementation, lint removal material layer 106 can be configured to remove lint when operated in a first direction. Such implementations typically include lint removal fabric. When operated in a different direction, such as in an opposite direction, lint removal material layer 106 has dramatically reduced capability to remove lint from a target surface. In some instances, operating lint removal material layer 106 in a direction opposite the lint removing direction results in lint removal material layer 106 shedding lint it has picked up.

Lint removal material layer 106 and base layer 104 are typically configured such that base layer 104 edges are substantially flush with lint removal material layer 106 edges. In some instances, the perimeter of lint removal device 102 is treated after lint removal material layer 106 and base layer 104 are connected. Example treatments include curing with heat or using a chemical additive. Treating the perimeter of lint removal device 102 can prevent or limit fraying along the perimeter. Treating the perimeter of lint removal device 102 can also prevent or minimize shedding of lint removal material layer 106 on target surfaces, such as clothing.

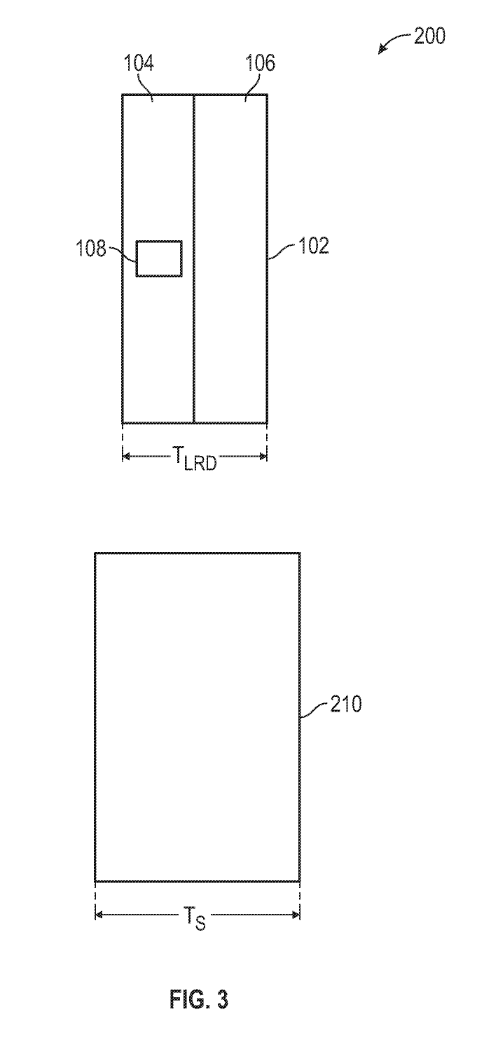

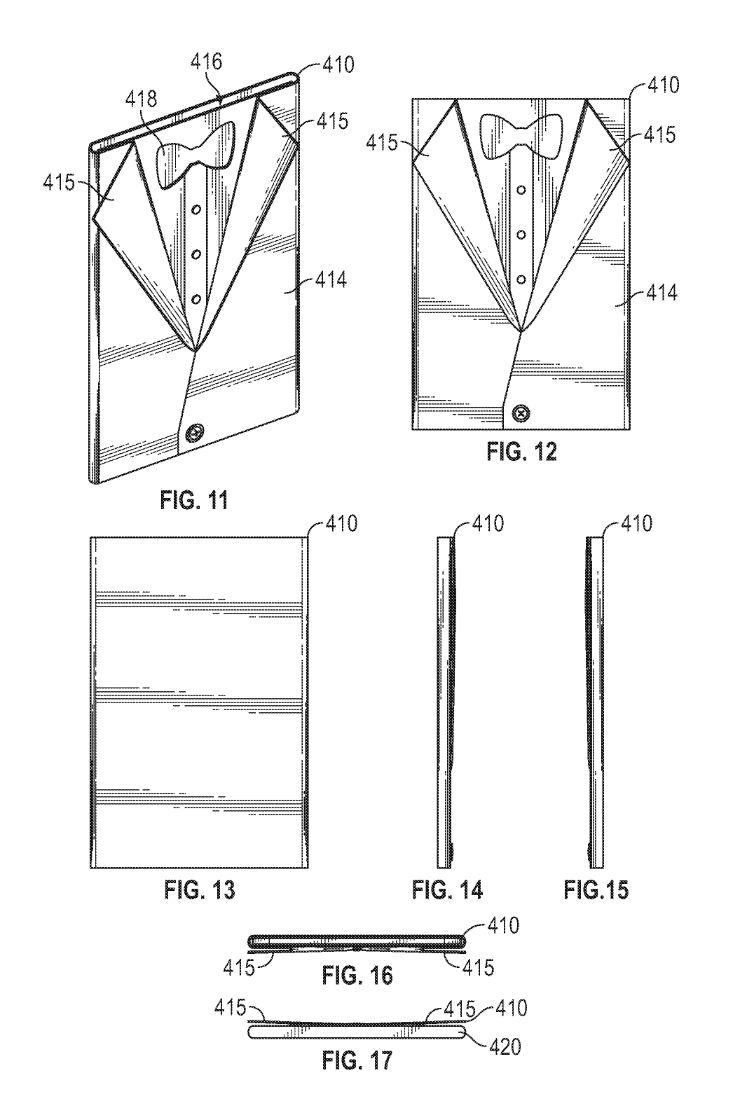

FIG. 3 is a schematic cross-sectional view of example lint removal system 200. Example system 200 includes lint removal device 102 and sleeve 210. Generally, lint removal device 102 is sized and arranged to fit within a cavity or space defined by sleeve 210. Broadly, sleeve 210 provides multiple additional surfaces upon which to place promotional images and/or functional arrangements, such as micro-fiber surfaces. Example configurations of sleeve 210 are described below with reference to, at least, FIGS. 11-21.

Sleeve 210 has slightly larger dimensions than lint removal device 102 such that lint removal device 102 forms a snug fit when positioned within sleeve 210. In order for lint removal device 102 to fit within sleeve 210, lint removal device 102 thickness T_{LRD} is less than sleeve 210 thickness T_{S}.

FIG. 4 is a schematic cross-sectional view of example lint removal device 302. Example lint removal device 302 includes some or all components as described above with reference to lint removal device 102. Example lint removal device 302 includes three layers: base layer 304, lint removal material layer 306, and other layer 308.

Other layer 308 is connected to base layer 304 to provide additional functionality and/or promotional surfaces. For example, other layer 308 can include micro-fiber material on some or all of the surface. As another example, other layer 308 is a textured surface, such as a smooth, glossy surface, or a surface having waves or brush-like features. In some instances, other layer 308 includes instructional material, such as an arrow indicating the proper direction to operate lint removal material layer 306 to remove lint. As another example, other layer 308 is a grip assembly, such as a strap affixed to base layer 304. One or more fingers can pass between the grip assembly and the base layer 304.

Additional materials usable as other layer 308 include reflective material, polyester material, nylon material, sticky material, information conveying material, and/or electrostatic material. Electrostatic force-inducing material can use electrostatic force to remove particles from surfaces. Information conveying material can be used to identify or share identity and/or source information, provide access (e.g. by unlocking doors), and the like. An example device configured to convey information includes a radio frequency identification receiver or transceiver. In some instances, lint removal device 302 can be used to trigger location-based actions, such as customer tracking and location-based promotions or rewards.

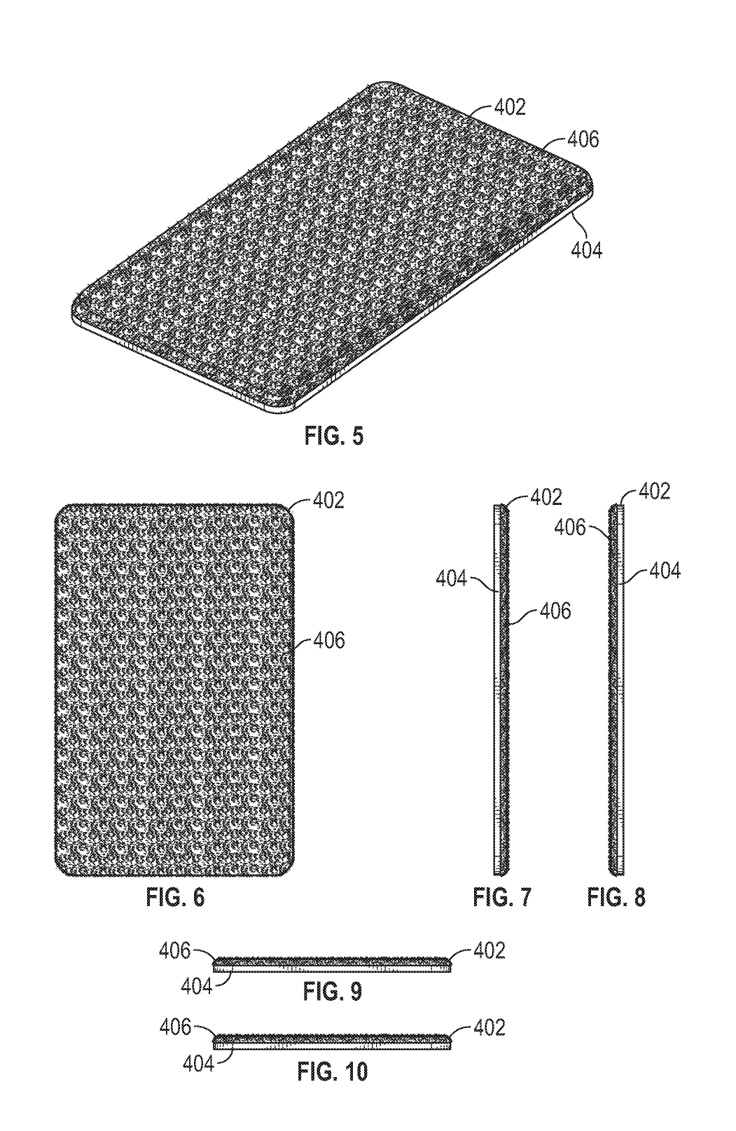

FIGS. 5-10 illustrate example lint removal device 402. FIG. 5 is a top, front right perspective view of lint removal device 402. FIG. 6 is a front plan view of lint removal device 402. FIG. 7 is a left side plan view of lint removal device 402. FIG. 8 is a right side plan view of lint removal device 402. FIG. 9 is a bottom plan view of lint removal device 402. FIG. 10 is a top plan view of lint removal device 402.

Lint removal device 402 includes two layers: base layer 404 and lint removal material layer 406. Lint removal material layer 406 includes lint removing fabric. Lint removing fabric includes lint removing features such as angled bristles arranged in a pattern. Base layer 404 and lint removal material layer 406 are sized such that base layer 404 edges are substantially flush with lint removal material layer 406 edges. The corners of lint removal device 402 are rounded.

In some embodiments, lint removal material layer 406 does not span the entirety of the upper surface of base layer 404. Other components can be included in unused area of base layer 404. For instance, a reflective surface may occupy unused area of base layer 404. As another example, there may be reference cut outs of lint removal material layer 406 to guide the user in thumb positioning.

FIGS. 11-17 illustrate example sleeve 410. FIG. 11 is a top, front left perspective view of sleeve 410. FIG. 12 is a front plan view of sleeve 410. FIG. 13 is a rear plan view of sleeve 410. FIG. 14 is a left side plan view of sleeve 410. FIG. 15 is a right side plan view of sleeve 410. FIG. 16 is a top plan view of sleeve 410. FIG. 17 is a bottom plan view of sleeve 410.

Sleeve 410 provides a protective case for lint removal device 402 as well as surfaces for decoration or promotion. Sleeve 410 defines slot 416, which is sized and configured to receive lint removal device 402. Sleeve 410 optionally includes bottom portion 420.

Sleeve 410 also includes decorative and/or promotional components. For instance, sleeve 410 includes tuxedo design 414, which includes folding portions 415 mimicking lapels of a tuxedo jacket. Sleeve 410 also defines decorative cutout 418 which is in the shape of a bowtie, complementing the tuxedo design 414. Decorative cutout 418 can also provide verification to the user that lint removal device 402 is within sleeve 410.

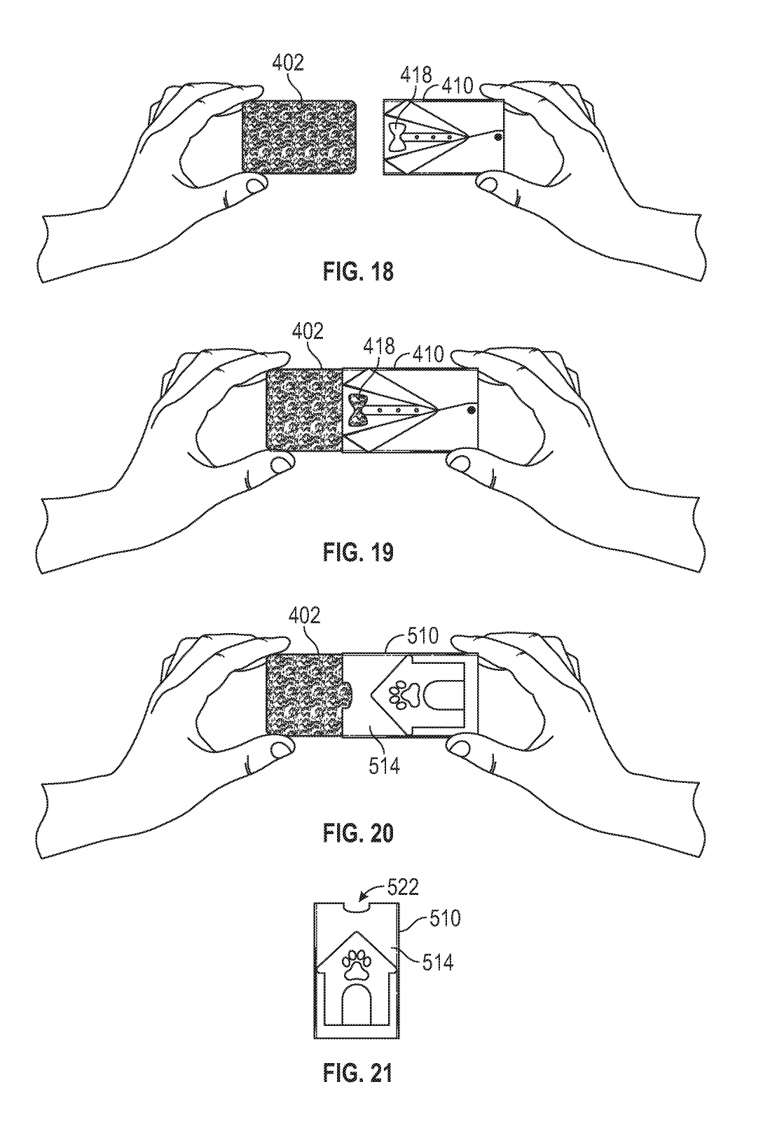

FIGS. 18-19 illustrate interaction between lint removal device 402 and sleeve 410. FIG. 18 shows a pre-mated condition and FIG. 19 shows a partially-mated condition. Visual effects of decorative cutout 418 are apparent when comparing FIG. 18 and FIG. 19. For instance, the bowtie decorative cutout 418 appears to acquire the pattern of lint removal device 402 when lint removal device 402 is inserted into sleeve 410.

FIG. 20 shows lint removal device 402 and sleeve 510. Sleeve 510 is depicted without lint removal device 402 in FIG. 21. Sleeve 510 defines access cutout 522 and does not include decorative cutouts, in contrast to sleeve 410. Sleeve 510 includes different promotional material printed on top surface 514.

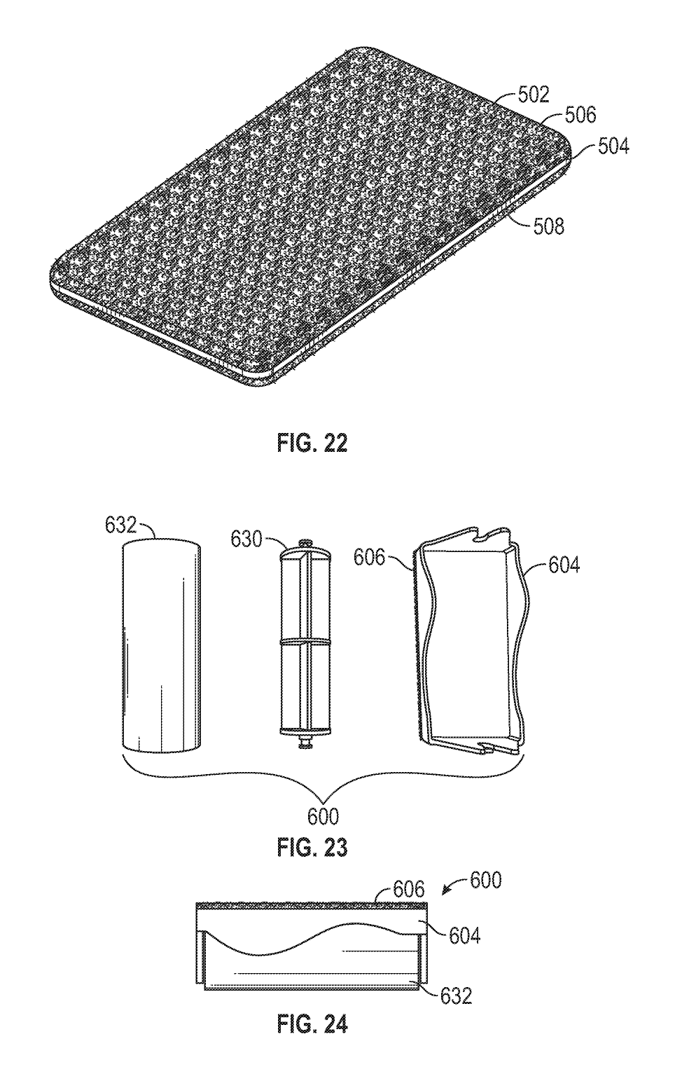

FIG. 22 is a front, top right perspective view of lint removal device 502. Lint removal device 502 includes three layers: lint removal material layer 506, base layer 504, and lint removal material layer 508. In the embodiment shown, lint removal material layer 506 and lint removal material layer 508 are sized the same and include the same lint-removing fabric.

In some embodiments, lint removal device is sized too large to fit in a wallet. FIGS. 23-24 illustrate lint removal device system 600. FIG. 23 is a disassembled view of lint removal device system 600. FIG. 24 is a side plan view of an assembled lint removal device system 600.

Lint removal device system 600 includes base 604 with lint removal material layer 606, roller 630, and sticky assembly 632. As shown, lint removal material layer 606 includes lint-removing fabric. Sticky assembly 632 couples with roller 630 and provides a tacky surface suited for lint removal. Roller 630 couples with base 604 such that roller 630 is rotatably coupled to base 604. By providing lint removal material layer 606 in combination with roller 630 and sticky assembly 632, costs associated with replacing sticky assembly 632 may be reduced.

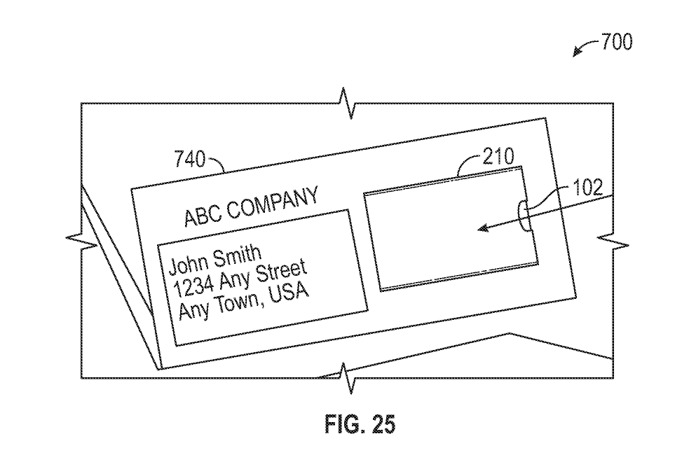

FIG. 25 shows example direct mail system 700. Direct mail system 700 includes mailer 740 having sleeve 210 affixed thereto. Lint removal device 102 is positioned within sleeve 210. Mailer 740 can be positioned within an envelope and include promotional data, such as an offer for an intended recipient. Pressure sensitive adhesive, such as fugitive glue, removably connects sleeve 210 to mailer 740. In some instances, direct mail system 700 does not include sleeve 210 and pressure sensitive adhesive removably connects lint removal device 102 to mailer 740.

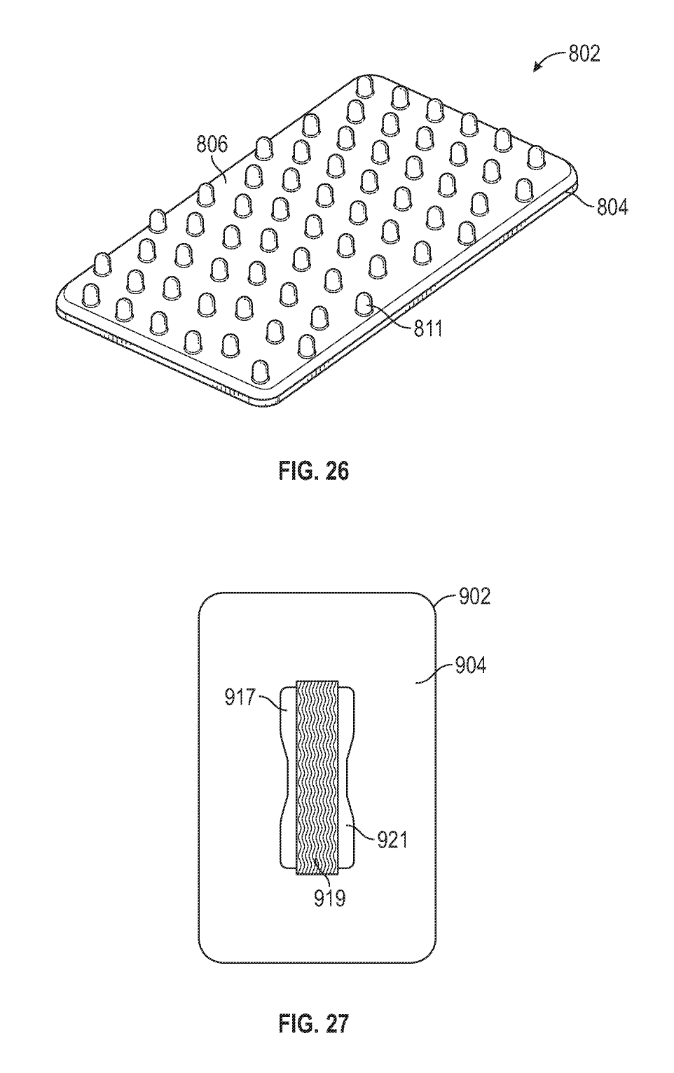

FIG. 26 is a top, front right perspective view of example lint removal device 802. Lint removal device 802 includes two layers: base layer 804 and lint removal material layer 806. Lint removal material layer 806 is a rubber compound-based material.

Lint removal material layer 806 includes lint removal features 811. As shown, lint removal features 811 are rounded, relatively stiff bristles angled substantially normal to the plane of base layer 804. As shown, lint removal features 811 are arranged in an alternating pattern. Other arrangements of lint removal features 811 are contemplated.

FIG. 27 is a plan view of example lint removal device 902. Lint removal device 902 includes base layer 904 and a lint removal material layer not shown. Lint removal device 902 also includes grip 917. Generally, grip 917 provides one or more surfaces for a user to use during operation of lint removal device 902. Grip 917 can have various sizes other than that shown in FIG. 27, but provides space for at least one finger to hold or brace against lint removal device 902.

As shown, grip 917 includes fixed portion 921 and flexible portion 919. Fixed portion 921 connects grip 917 to base layer 904. A user can position one or more fingers in the loop formed by fixed portion 921 and flexible portion 919. Flexible portion 919 can be made of an elastic material to accommodate various finger sizes while still maintaining a degree of force against the fingers within grip 917.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

What is claimed is:

1. A lint removal device, comprising:
a base layer; and
a lint removal material layer,
the lint removal material layer being connected to the base layer;
the lint removal material layer including lint removing features, the lint removing features arranged and configured to collect lint; and
the lint removal material layer being sized such that base layer edges are substantially flush with lint removal material layer edges.

2. The lint removal device according to claim 1, the base layer having a thickness no greater than 5 mm; and
the lint removal material layer being lint removal fabric.

3. The lint removal device according to claim 2, the base layer having a width between 3 to 4 inches and a length between 2 to 2.5 inches; and
the base layer thickness being no less than 0.75 mm and no greater than 1.25 mm.

4. The lint removal device according to claim 1, the base layer including promotional images; and
the lint removal material layer being rubber-based material.

5. The lint removal device according to claim 1, the lint removal material layer and the base layer being sized similarly such that the lint removal material layer covers a surface of the base layer; and
at least a portion of each of the base layer edges and the lint removal material layer edges being cured with heat or chemical additive.

6. The lint removal device according to claim 1, further comprising a third layer connected to the base layer at an opposite surface of the base layer in relation to the lint removal material layer.

7. The lint removal device according to claim 6, the third layer including microfiber material.

8. The lint removal device according to claim 6, the third layer including a second lint removal material layer.

9. The lint removal device according to claim 6, the third layer including operational instructions, the operational instructions indicating an operative direction to use the lint removal material layer.

10. The lint removal device according to claim 6, the third layer including a grip.

11. The lint removal device according to claim 6, the third layer including rubber lint removing material.

12. The lint removal device according to claim 1, the base layer including a base layer additive.

13. The lint removal device according to claim 12, the base layer additive including a magnetic component.

14. The lint removal device according to claim 12, the base layer additive including an antimicrobial additive.

15. The lint removal device according to claim 1, further comprising a pressure sensitive adhesive in contact with the base layer, the pressure sensitive adhesive being in contact with a direct mailer.

16. A lint removal device system, comprising:
a lint removal device, including:
a base layer; and
a lint removal material layer,
the lint removal material layer being mounted on the base layer;
the lint removal material layer including lint removing features, the lint removing features arranged and configured to collect lint; and
the lint removal material layer being sized such that base layer edges are substantially flush with lint removal material layer edges; and
a sleeve configured to receive the lint removal device.

17. The lint removal device system according to claim 16, the sleeve defining at least one decorative cutout; and
the lint removal material layer including lint removal fabric.

18. The lint removal device system according to claim 16, the base layer including promotional images;
the lint removal material layer and the base layer being sized similarly such that the lint removal material layer covers a surface of the base layer; and
the lint removal device further comprising a third layer connected to the base layer at an opposite surface of the base layer in relation to the lint removal material layer.

19. A lint removal device, including:
a base layer,
the base layer having a thickness no greater than 5 mm; and
the base layer including promotional matter;
a lint removal material layer,
the lint removal material layer being adhesively connected to the base layer;
the lint removal material layer including lint removing features, the lint removing features arranged and configured to collect lint; and
the lint removal material layer being sized such that base layer edges are substantially flush with lint removal material layer edges.

20. The lint removal device according to claim 19, the base layer having a width between 3 to 4 inches and a length between 2 to 2.5 inches;
the base layer thickness being no less than 0.75 mm and no greater than 1.25 mm; and further comprising:
a sleeve configured to receive the lint removal device; and
a third layer connected to the base layer at an opposite surface of the base layer in relation to the lint removal material layer, the third layer including at least one of: microfiber material, a second lint removal material layer, operational instructions, a grip, and rubber lint removing material.

21. The lint removal device according to claim 1, wherein lint is at least one of: hair, dust, and textile fiber.
